(19) United States
(12) Patent Application Publication
(10) Pub. No.: US 2010/0188848 A1
(43) Pub. Date: Jul. 29, 2010

(54) ELECTRO-THERMAL SEPARATION LIGHT EMITTING DIODE LIGHT ENGINE MODULE

(76) Inventor: Been-Yu LIAW, Sindian City (TW)

Correspondence Address: Muncy, Geissler, Olds & Lowe, PLLC, 4000 Legato Road, Suite 310, FAIRFAX, VA, 22033, US

(21) Appl. No.: 12/361,160

(22) Filed: Jan. 28, 2009

(51) Int. Cl. F21S 4/00; F21V 21/00

(52) U.S. Cl. 362/249.02; 362/249.01

(57) ABSTRACT

An electro-thermal separation light emitting diode light engine module includes a heat dissipater, an illuminating module and a printed circuit board. The illuminating module is provided on the heat dissipater and is provided with at least one contact end. The printed circuit board is transfixed with at least one hole for accepting the illuminating module and is provided with a circuit for electrically connecting the contact end. Therefore, the illuminating module can be cooled directly through the heat dissipater and can be connected electrically by the circuit of the printed circuit board, achieving the practical progressiveness by providing a better heat dissipation effect and reducing cost.

### BACKGROUND OF THE INVENTION

a) Field of the Invention

The present invention relates to a light engine module, and more particularly to an electro-thermal separation LED (light emitting diode) light engine module, a heat dissipation efficiency of which can be increased and cost of which can be reduced.

b) Description of the Prior Art

As a light emitting diode is provided with advantages of having a high illumination efficiency, a long service time, not being damaged easily, consuming less electricity, being environmental benign and having a small volume, it has been one of the most important light sources in recent years. In early years, as the light emitting diode does not have sufficient luminance, it was often used in an indicating lamp or a display panel. However, due to recent breakthrough in material science and technology, the luminance of the light emitting diode has already been improved significantly, especially that as a white-light light emitting diode emerges, existing conventional illuminating equipment has been gradually replaced by the light emitting diode.

However, when the light emitting diode is used in a long time, energy it releases must be dissipated effectively by a heat dissipater. Referring to FIG. 1 and FIG. 2, it shows a three-dimensional view and a cutaway view of a conventional LED heat dissipation module. An LED heat dissipation module 1 includes a heat dissipater 11, an aluminum substrate 12 and an LED illuminating module 13, wherein the aluminum substrate 11 is in a plate shape and is provided on the heat dissipater 11, with a layer of dielectric layer, which is insulating and is provided with a heat conduction effect, being installed on the aluminum substrate 12. In addition, the aluminum substrate 12 is provided with a circuit, the LED illuminating module 13 is provided on the aluminum substrate 12 and is extended with at least one contact end 131 which can be electrically connected with the circuit. A layer of thermal paste 132 is coated between the LED illuminating module 13 and the aluminum substrate 12, so as to acquire a better heat conduction effect.

By the aforementioned structures, the LED illuminating module 13 is able to use that circuit to accomplish a serial or parallel connection, and heat from the LED illuminating module 13 can be conducted by the dielectric layer to the heat dissipater 11 for cooling. Nevertheless, upon using the aforementioned LED heat dissipation module 1, following problems and shortcomings actually exist to be improved:
1. Although the conventional LED heat dissipation module 1 was able to use the aluminum substrate 12 to achieve at a same time the effects of electric connection and heat dissipation, the heat conduction sequence of the conventional LED heat dissipation module 1 includes that heat is conducted from the LED illuminating module 13 to the thermal paste 132 first, the thermal paste 132 then conducts the heat to the aluminum substrate 12, and then the aluminum substrate 12 conducts the heat to the heat dissipater 11. Therefore, the more the media is for conducting the heat, the less the heat that is dissipated by the heat dissipater 11, which further results in an issue of an inferior heat dissipation effect.
2. Although the aluminum substrate 12 is provided at the same time the effects of electric connection and heat dissipation, price will also be very expensive for the aluminum substrate 12 due to these extraordinary features, which will increase cost of manufacturers and also be a great burden to consumers.

Accordingly, how to solve the aforementioned problems and shortcomings of the prior art, is a technological issue of research and development for improvement by the present inventor and related vendors.

### SUMMARY OF THE INVENTION

The primary object of the present invention is to provide an electro-thermal separation light emitting diode light engine module which includes a heat dissipater, an illuminating module and a printed circuit board, wherein the illuminating module is extended with at least one contact end and is provided on the heat dissipater, the printed circuit board is transfixed with at least one hole for accepting the illuminating module, is fixedly provided on the heat dissipater, and is provided with a circuit for connecting the contact end. As the illuminating module of the present invention is directly provided on the heat dissipater, heat released from the illuminating module can be directly dissipated by the heat dissipater for cooling. By the aforementioned technologies, the issue existing in the conventional LED heat dissipation module that the heat dissipation effect is poor can be broken through, thereby increasing the heat dissipation efficiency to achieve the practical progressiveness.

Another object of the present invention is provided an electro-thermal separation light emitting diode light engine module which includes the heat dissipater, the illuminating module and the printed circuit board, wherein the printed circuit board is provided with the circuit for electrically connecting the contact end of the illuminating module, and the light engine module of the present invention uses a cheaper printed circuit board to attain the effect of electric connection, without using the more expensive aluminum substrate. Accordingly, by the aforementioned technologies, the issue existing in the conventional LED heat dissipation module that cost is too high can be solved, thereby saving the cost to achieve the practical progressiveness.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional view of a conventional LED heat dissipation module.

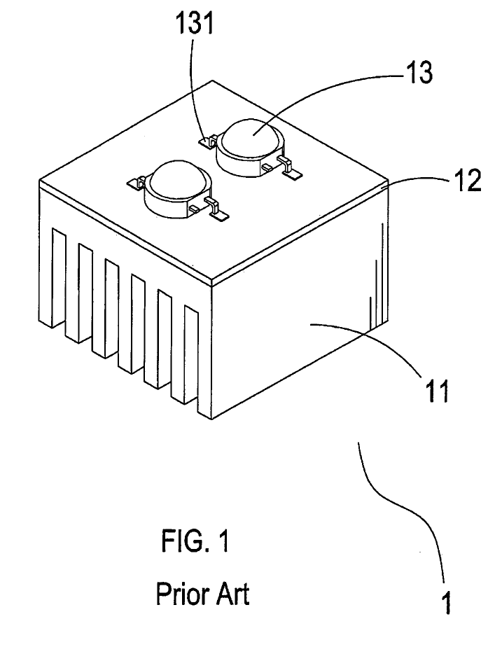

FIG. 2 shows a cutaway view of a conventional LED heat dissipation module.

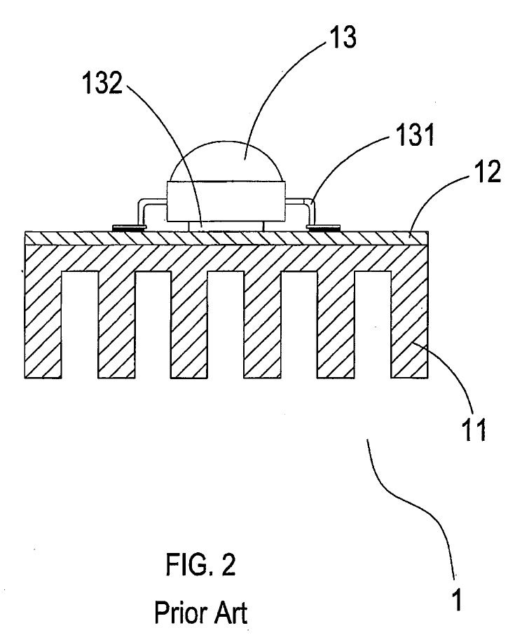

FIG. 3 shows a three-dimensional view of a preferred embodiment of the present invention.

FIG. 4 shows a three-dimensional exploded view of a preferred embodiment of the present invention.

FIG. 5 shows a cutaway view of a preferred embodiment of the present invention.

FIG. 6 shows a cutaway view of another preferred embodiment of the present invention.

FIG. 7 shows a cutaway view of still another preferred embodiment of the present invention.

FIG. 8 shows a first schematic view of an implementation of the preferred embodiment of the present invention.

FIG. 9 shows a second schematic view of an implementation of the preferred embodiment of the present invention.

### DETAILED DESCRIPTION OF THE PREFERRED EMBODIMENTS

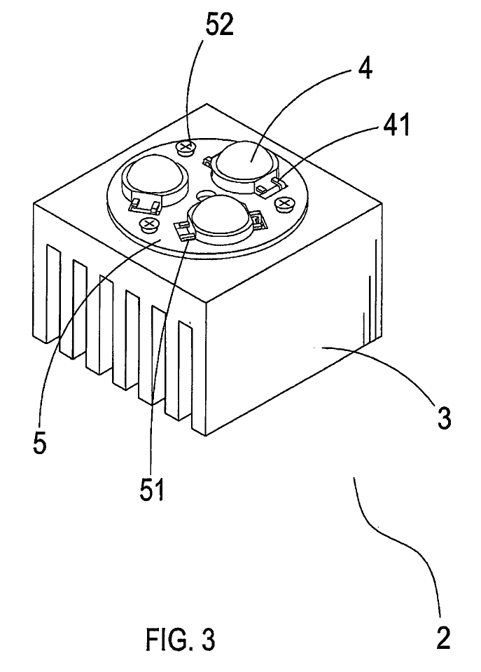

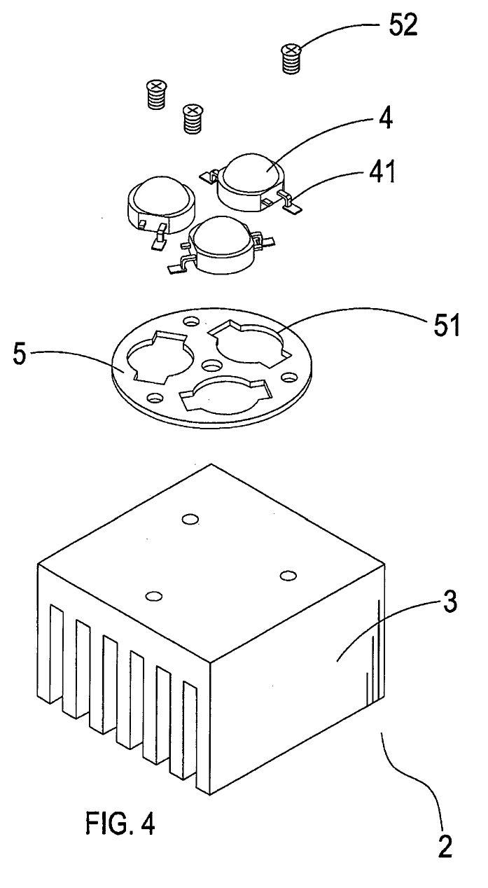

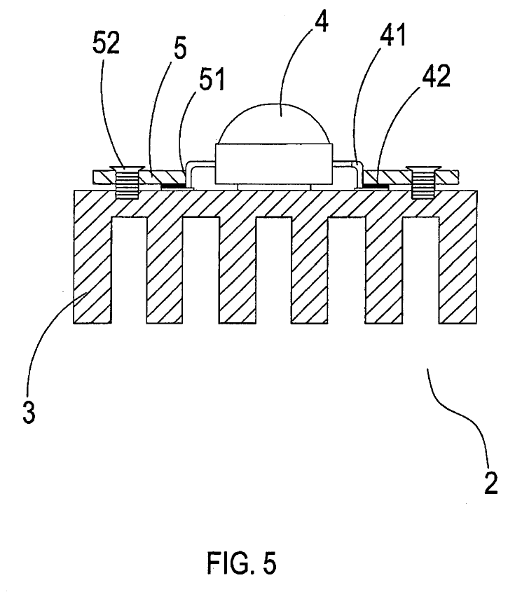

Referring to FIGS. 3 to 5, it shows a three-dimensional view, a three-dimensional exploded view and a cutaway view of a preferred embodiment of the present invention. A light engine module 2 of the present invention comprises a heat dissipater 3 which can be a fin-type heat dissipater 3 to attain a better heat dissipation effect; at least one illuminating module 4 which is extended with at least one contact end 41, with the contact end 41 being extended as a pin and the illuminating module 4 being provided on the heat dissipater 3; and a printed circuit board 5 which is transfixed with at least one hole 51 for accepting the illuminating module 4, and which is fixedly provided on the heat dissipater 3 by screw elements 52, with a bottom surface of the printed circuit board 5 being provided with a circuit for electrically connecting the contact end 41, the contact end 41 being fixed on the circuit by a solder 42, and the printed circuit board 5 being a multi-layer printed circuit board 5.

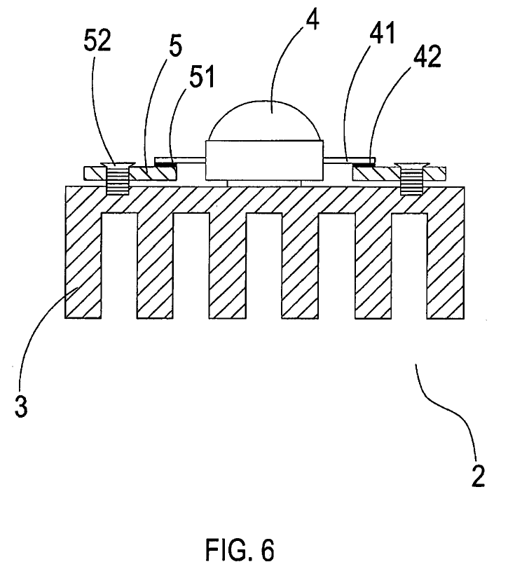

Referring to FIG. 6, it shows a cutaway view of another preferred embodiment of the present invention. A light engine module 2 of the present invention comprises a heat dissipater 3 which can be a fin-type heat dissipater 3 to attain a better heat dissipation effect; at least one illuminating module 4 which is extended with at least one contact end 41, with the contact end 41 being extended as a pin and the illuminating module 4 being provided on the heat dissipater 3; and a printed circuit board 5 which is transfixed with at least one hole 51 for accepting the illuminating module 4, and which is fixedly provided on the heat dissipater 3 by screw elements 52, with a top surface of the printed circuit board 5 being provided with a circuit for electrically connecting the contact end 41, the contact end 41 being fixed on the circuit by a solder 42, and the printed circuit board 5 being a multi-layer printed circuit board 5.

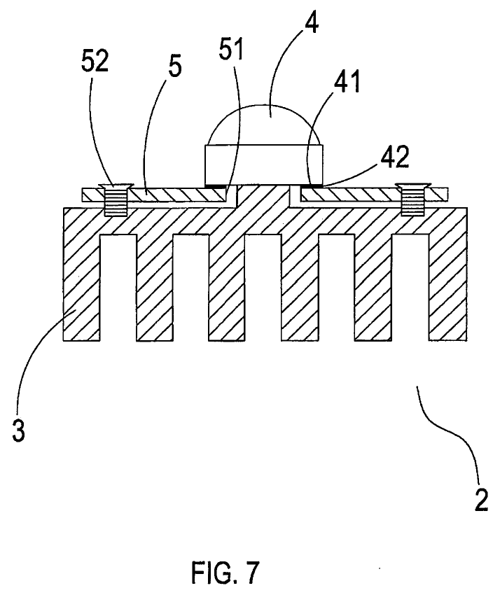

Referring to FIG. 7, it shows a cutaway view of still another preferred embodiment of the present invention. A light engine module 2 of the present invention comprises a heat dissipater 3 which can be a fin-type heat dissipater 3 to attain a better heat dissipation effect; at least one illuminating module 4 which is extended with at least one contact end 41, can be a surface-mount-type illuminating module 4, and is provided on the heat dissipater 3; and a printed circuit board 5 which is transfixed with at least one hole 51 for accepting the illuminating module 4, and which is fixedly provided on the heat dissipater 3 by screw elements 52, with a top surface of the printed circuit board 5 being provided with a circuit for electrically connecting the contact end 41, the contact end 41 being fixed on the circuit by a solder 42, and the printed circuit board 5 being a multi-layer printed circuit board 5.

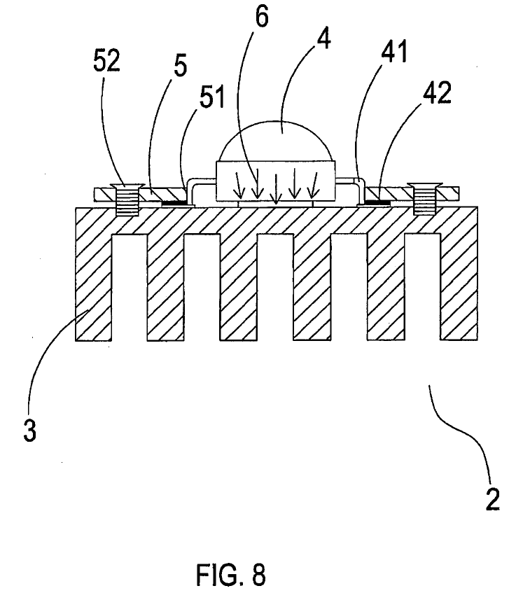

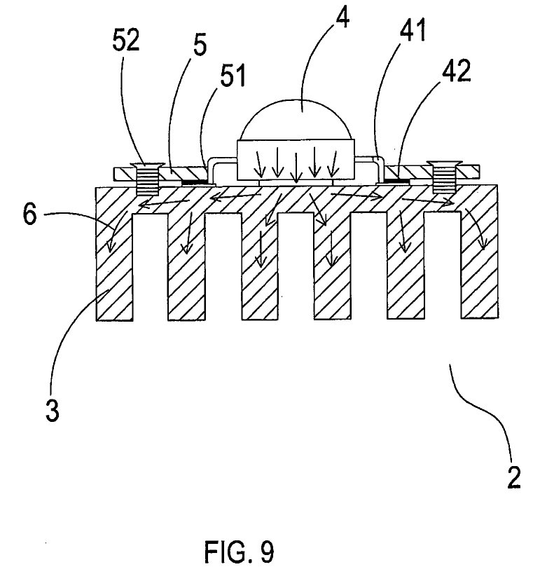

Referring to FIG. 8 and FIG. 9, it shows a first schematic view and a second schematic view, of an implementation of the preferred embodiment of the present invention. When the light engine module 2 of the present invention is in use, as the illuminating module 4 is directly provided on the heat dissipater 3, heat 6 generated by the illuminating module 4 can be conducted directly to the heat dissipater 3, so as to achieve the practical progressiveness by providing the better heat dissipation effect.

Moreover, as the printed circuit board 5 is transfixed with at least one hole 51 for accepting the illuminating module 4, the printed circuit board 5 can be directly sheathed with the illuminating module 4 and fixed on the heat dissipater 3 by the screw elements 52. On the other hand, the printed circuit board 5 is provided with the circuit for electrically connecting the contact end 41 of the illuminating module 4, therefore, the illuminating module 4 can be connected serially or parallel, freely.

Accordingly, the present invention utilizes this concept of electro-thermal separation to effectively separate the transmission of the circuit and the dissipation of the heat 6, achieving the effects of providing the better heat dissipation effect and reducing the cost.

Referring to all the drawings, the present invention is actually provided with following advantages in comparison with the prior art:
1. As the illuminating module 4 of the present invention is directly fixed on the heat dissipater 3, the heat 6 from the illuminating module 6 can be conducted directly to the heat dissipater 3 to be dissipated, which improves the issue existing in the prior art that the heat dissipation effect is inferior as the heat has to be conducted through layers of media.
2. As the printed circuit board 5 of the present invention is provided with the circuit for electrically connecting the contact end 41 of the illuminating module 4, the issue existing in the conventional illuminating module 4 that the expensive aluminum substrate has to be used for electric connection is improved, thereby achieving the effect of reducing the cost.

It is of course to be understood that the embodiments described herein is merely illustrative of the principles of the invention and that a wide variety of modifications thereto may be effected by persons skilled in the art without departing from the spirit and scope of the invention as set forth in the following claims.

1. An electro-thermal separation light emitting diode light engine module comprising a fin-type heat dissipater; at least one LED illuminating module which is extended with at least one contact end, and is provided on the heat dissipater;
and a multi-layer printed circuit board which is transfixed with at least one hole for accepting the illuminating module and is fixedly provided on the heat dissipater by screw elements, with the printed circuit board being provided with a circuit for electrically connecting the contact end;
wherein the heat transmission and the electrical transmission are separate.

2. (canceled)

3. (canceled)

4. (canceled)

5. The electro-thermal separation light emitting diode light engine module, according to claim 1, wherein the contact end is electrically connected to the circuit by fixing with a solder.

6. (canceled)

7. The electro-thermal separation light emitting diode light engine module, according to claim 1, wherein the contact end is extended with a pin.
